(19) United States
(12) Patent Application Publication
(10) Pub. No.: US 2024/0272285 A1
(43) Pub. Date: Aug. 15, 2024

(54) LIGHT SOURCE CONTROL DEVICE, LIGHT SOURCE CONTROL METHOD, AND DISTANCE MEASURING DEVICE

(71) Applicant: SONY SEMICONDUCTOR SOLUTIONS CORPORATION, KANAGAWA (JP)

(72) Inventor: TAKAHIRO KADO, KANAGAWA (JP)

(21) Appl. No.: 18/568,317

(22) PCT Filed: Feb. 15, 2022
(86) PCT No.: PCT/JP2022/005800

§ 371 Date: Dec. 8, 2023

(30) Foreign Application Priority Data
Jun. 18, 2021 (JP) 2021-101371

(51) Int. Cl. G01S 7/484; G01S 7/481; G01S 17/931

(52) U.S. Cl. CPC G01S 7/484; G01S 7/4817; G01S 17/931

(57) ABSTRACT

The present technology relates to a light source control device, a light source control method, and a distance measuring device that can improve the resolution of a distance measuring device that uses a light source having a plurality of light-emitting regions. The light source control device includes a light source control unit that drives a light source in which n (n is 4 or more) light-emitting regions, which emit irradiation light individually, are arranged in a first direction in units of predetermined time Δt, wherein the light source control unit causes the irradiation light to be emitted m times (m is 2 or more) from each of the light-emitting regions every time the irradiation light is scanned by a predetermined angle in a third direction perpendicular to a second direction corresponding to the first direction and sets an emission interval of each of the light-emitting regions to 2Δt or more and less than nΔt. The present technology can be applied to LiDAR, for example.

### TECHNICAL FIELD

The present technology relates to a light source control device, a light source control method, and a distance measuring device, and particularly relates to a light source control device, a light source control method, and a distance measuring device that improve the resolution of the distance measuring device.

### BACKGROUND ART

Conventionally, it has been proposed to use a light source including a plurality of light-emitting regions (for example, a plurality of laser diodes) in a distance measuring device (see, for example, PTL 1).

### CITATION LIST

### Patent Literature

[PTL 1]
JP 2020-118569A

### SUMMARY

### Technical Problem

However, in the invention described in PTL 1, a method for controlling a plurality of light-emitting regions is not particularly studied.

The present technology has been developed in view of this situation, and is intended to improve the resolution of a distance measuring device that uses a light source having a plurality of light-emitting regions.

### Solution to Problem

A light source control device according to a first aspect of the present technology includes a light source control unit that drives a light source in which n (n is 4 or more) light-emitting regions, which emit irradiation light individually, are arranged in a first direction in units of predetermined time Δt, wherein the light source control unit causes the irradiation light to be emitted m times (m is 2 or more) from each of the light-emitting regions every time the irradiation light is scanned by a predetermined angle in a third direction perpendicular to a second direction corresponding to the first direction and sets an emission interval of each of the light-emitting regions to 2Δt or more and less than nΔt.

A light source control method according to a first aspect of the present technology includes driving a light source in which n (n is 4 or more) light-emitting regions, which emit irradiation light individually, are arranged in a first direction in units of predetermined time Δt; causing the irradiation light to be emitted m times (m is 2 or more) from each of the light-emitting regions every time the irradiation light is scanned by a predetermined angle in a third direction perpendicular to a second direction corresponding to the first direction; and setting an emission interval of each of the light-emitting regions to 2Δt or more and less than nΔt.

In the first aspect of the present technology, the irradiation light is emitted m times (m is 2 or more) from each of the light-emitting regions every time the irradiation light is scanned by a predetermined angle in a third direction perpendicular to a second direction corresponding to the first direction and the emission interval of each of the light-emitting regions is set to 2Δt or more and less than nΔt.

A distance measuring device according to a second aspect of the present technology includes a light source in which n (n is 4 or more) light-emitting regions, which emit irradiation light individually, are arranged in a first direction; a light source control unit that drives the light source in units of predetermined time Δt; a scanning unit that scans the irradiation light in a third direction perpendicular to a second direction corresponding to the first direction; a light-receiving unit that receives incident light including reflected light of the irradiated light; and a distance measuring unit that measures a distance based on the incident light, wherein the light source control unit causes the irradiation light to be emitted m times (m is 2 or more) from each of the light-emitting regions every time the irradiation light is scanned by a predetermined angle in the third direction and sets an emission interval of each of the light-emitting regions to 2Δt or more and less than nΔt.

In the second aspect of the present technology, the irradiation light is emitted m times (m is 2 or more) from each of the light-emitting regions every time the irradiation light is scanned by a predetermined angle in a third direction perpendicular to a second direction corresponding to the first direction and the emission interval of each of the light-emitting regions is set to 2Δt or more and less than nΔt.

### BRIEF DESCRIPTION OF DRAWINGS

FIG. 1 is a block diagram showing a configuration example of a vehicle control system.

FIG. 2 is a diagram showing an example of sensing regions.

FIG. 3 is a block diagram showing an embodiment of LiDAR to which the present technology is applied.

FIG. 4 is a diagram showing an example of the configuration of LD channels.

FIG. 5 is a plan view of a LiDAR optical system.

FIG. 6 is a graph showing a first example of emission timing of irradiation light of each channel.

FIG. 7 is a diagram showing a first example of the irradiation direction of the irradiation light of each channel.

FIG. 8 is a graph showing a second example of the emission timing of irradiation light of each channel.

FIG. 9 is a graph showing a third example of the emission timing of irradiation light of each channel.

FIG. 10 is a diagram showing a second example of the irradiation direction of the irradiation light of each channel.

FIG. 11 is a graph showing a fourth example of the emission timing of irradiation light of each channel.

FIG. 12 is a graph showing a fifth example of emission timing of irradiation light of each channel.

FIG. 13 is a graph showing a sixth example of the emission timing of irradiation light of each channel.

### DESCRIPTION OF EMBODIMENTS

An embodiment for implementing the present technique will be described below. The description will be made in the following order.
1. Configuration example of vehicle control system
2. Embodiment
3. Modification Example
4. Others

### 1. Configuration Example of Vehicle Control System

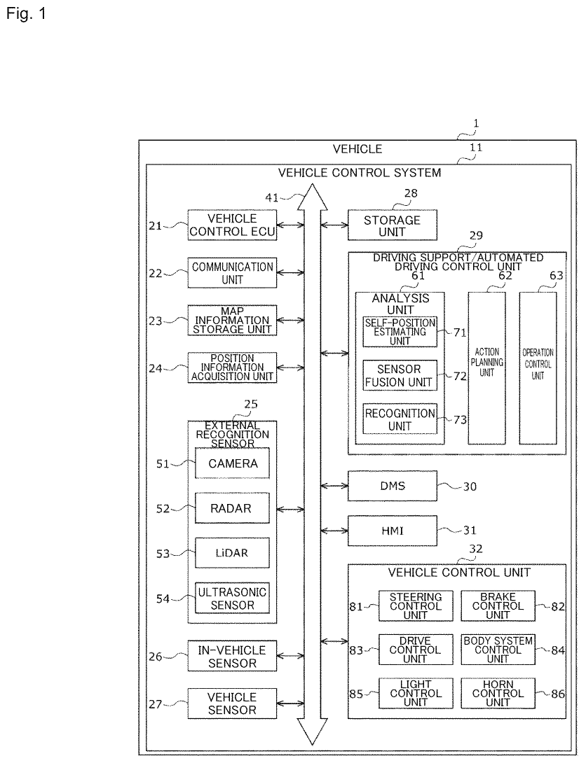

FIG. 1 is a block diagram showing a configuration example of a vehicle control system 11 being an example of a mobile device control system to which the present technique is to be applied.

The vehicle control system 11 is provided in a vehicle 1 and performs processing related to driving support and automated driving of the vehicle 1.

The vehicle control system 11 includes a vehicle control ECU (Electronic Control Unit) 21, a communication unit 22, a map information storage unit 23, a position information acquisition unit 24, an external recognition sensor 25, an in-vehicle sensor 26, a vehicle sensor 27, a storage unit 28, a driving support/automated driving control unit 29, a DMS (Driver Monitoring System) 30, an HMI (Human Machine Interface) 31, and a vehicle control unit 32.

The vehicle control ECU 21, the communication unit 22, the map information storage unit 23, the position information acquisition unit 24, the external recognition sensor 25, the in-vehicle sensor 26, the vehicle sensor 27, the storage unit 28, the driving support/automated driving control unit 29, the driver monitoring system (DMS) 30, the human machine interface (HMI) 31, and the vehicle control unit 32 are connected to each other via a communication network 41 so that they can communicate with each other. The communication network 41 is configured by a vehicle-mounted network compliant with digital two-way communication standards such as CAN (Controller Area Network), LIN (Local Interconnect Network), LAN (Local Area Network), FlexRay (registered trademark), and Ethernet (registered trademark, a bus, and the like. The communication network 41 may be used differently depending on the type of data to be transmitted. For example, CAN may be applied to data related to vehicle control, and Ethernet may be applied to large-capacity data. Note that each unit of the vehicle control system 11 may be directly connected using wireless communication that assumes communication over a relatively short distance, such as near field communication (NFC) or Bluetooth (registered trademark) without involving the communication network 41.

Hereinafter, when each unit of the vehicle control system 11 is to communicate via the communication network 41, a description of the communication network 41 will be omitted. For example, when the vehicle control ECU 21 and the communication unit 22 perform communication via the communication network 41, it is simply stated that the vehicle control ECU 21 and the communication unit 22 perform communication.

The vehicle control ECU 21 is configured by, for example, various processors such as a CPU (Central Processing Unit) and an MPU (Micro Processing Unit). The vehicle control ECU 21 controls the entire or part of the functions of the vehicle control system 11.

The communication unit 22 communicates with various devices inside and outside the vehicle, other vehicles, servers, base stations, and the like and performs transmission/reception of various kinds of data. At this time, the communication unit 22 can perform communication using a plurality of communication methods.

Communication with the outside of the vehicle that can be performed by the communication unit 22 will be schematically explained. The communication unit 22 communicates with a server (hereinafter referred to as an external server) located in the external network via a base station or an access point using a wireless communication method such as 5G (fifth-generation mobile communication system), LTE (Long Term Evolution), or DSRC (Dedicated Short Range Communications). The external network with which the communication unit 22 communicates is, for example, the Internet, a cloud network, or a network unique to an operator. The communication method that the communication unit 22 performs with the external network is not particularly limited as long as it is a wireless communication method that allows digital two-way communication at a predetermined communication speed or higher and over a predetermined distance or longer.

Furthermore, for example, the communication unit 22 can communicate with a terminal located near the host vehicle using P2P (Peer To Peer) technology. Terminals that exist near the host vehicle include, for example, terminals worn by moving objects that move at relatively low speeds such as pedestrians and bicycles, terminals that are installed at fixed locations in stores, or MTC (Machine Type Communication) terminals. Furthermore, the communication unit 22 can also perform V2X communication. V2X communication refers to communication between the host vehicle and another vehicle, such as, for example, vehicle-to-vehicle communication with another vehicle, vehicle-to-infrastructure communication with roadside devices or the like, vehicle-to-home communication with home, and vehicle-to-pedestrian communication with terminals owned by pedestrians or the like.

The communication unit 22 can receive, for example, a program for updating software that controls the operation of the vehicle control system 11 from the outside (over the air). The communication unit 22 can further receive map information, traffic information, information around the vehicle 1, and the like from the outside. Further, for example, the communication unit 22 can transmit information regarding the vehicle 1, information around the vehicle 1, and the like to the outside. The information regarding the vehicle 1 that the communication unit 22 transmits to the outside includes, for example, data indicating the state of the vehicle 1, recognition results obtained by the recognition unit 73, and the like. For example, the communication unit 22 performs communication accommodating vehicle emergency notification systems such as eCall.

For example, the communication unit 22 receives electromagnetic waves transmitted by a Vehicle Information and Communication System (VICS (registered trademark)) using a radio beacon, a light beacon, FM multiplex broadcast, and the like.

Communication with the inside of the vehicle that can be executed by the communication unit 22 will be schematically explained. The communication unit 22 can communicate with each device in the vehicle using, for example, wireless communication. The communication unit 22 can perform wireless communication with devices in the vehicle using a communication method such as wireless LAN, Bluetooth, NFC, or WUSB (Wireless USB) that allows digital two-way communication at a predetermined communication speed or higher through wireless communication. The communication unit 22 is not limited to this, and can also communicate with each device in the vehicle using wired communication. For example, the communication unit 22 can communicate with each device in the vehicle through wired communication via a cable connected to a connection terminal (not shown). The communication unit 22 can communicate with each device in the vehicle using a communication method such as USB (Universal Serial Bus), HDMI (High-Definition Multimedia Interface) (registered trademark), and MHL (Mobile High-definition Link) that allows digital two-way communication at a predetermined communication speed or higher through wired communication.

Here, the in-vehicle device refers to, for example, a device that is not connected to the communication network 41 in the vehicle. Examples of in-vehicle devices include mobile devices and wearable devices carried by passengers such as drivers, information devices brought into the vehicle and temporarily installed, and the like.

The map information storage unit 23 stores one or both of a map acquired from the outside and a map created by the vehicle 1. For example, the map information storage unit 23 accumulates a three-dimensional high-precision map, a global map which is less precise than the high precision map but which covers a wide area, and the like.

Examples of high-precision maps include dynamic maps, point cloud maps, vector maps, and the like. The dynamic map is, for example, a map composed of four layers of dynamic information, semi-dynamic information, semi-static information, and static information, and is provided to the vehicle 1 from an external server or the like. The point cloud map is a map composed of point clouds (point cloud data). The vector map is a map that is compatible with ADAS (Advanced Driver Assistance System) and AD (Autonomous Driving) by associating traffic information such as positions of lanes and traffic lights with a point cloud map.

For example, the point cloud map and the vector map may be provided by an external server or the like or created by the vehicle 1 as a map to be matched with a local map (to be described later) based on sensing results by a camera 51, a radar 52, a LiDAR 53 or the like and accumulated in the map information storage unit 23. In addition, when a high-precision map is to be provided by an external server or the like, in order to reduce communication capacity, map data of, for example, a square with several hundred meters per side regarding a planned path to be traveled by the vehicle 1 is acquired from the external server or the like.

The position information acquisition unit 24 receives a GNSS signal from a GNSS (Global Navigation Satellite System) satellite and acquires position information of the vehicle 1. The acquired position information is supplied to the driving support/automated driving control unit 29. Note that the position information acquisition unit 24 is not limited to the method using GNSS signals, and may acquire position information using a beacon, for example.

The external recognition sensor 25 includes various sensors used to recognize a situation outside of the vehicle 1 and supplies each unit of the vehicle control system 11 with sensor data from each sensor. The external recognition sensor 25 may include any type of or any number of sensors.

For example, the external recognition sensor 25 includes the camera 51, the radar 52, the LiDAR (Light Detection and Ranging, Laser Imaging Detection and Ranging) 53, and an ultrasonic sensor 54. The configuration is not limited to this, and the external recognition sensor 25 may include one or more types of sensors among the camera 51, the radar 52, the LiDAR 53, and the ultrasonic sensor 54. The number of cameras 51, radars 52, LiDAR 53, and ultrasonic sensors 54 is not particularly limited as long as it can be realistically installed in vehicle 1. Further, the types of sensors included in the external recognition sensor 25 are not limited to this example, and the external recognition sensor 25 may include other types of sensors. Examples of sensing regions of each sensor included in the external recognition sensor 25 will be described later.

Note that the photographing method of the camera 51 is not particularly limited. For example, cameras with various photographing methods such as a ToF (Time Of Flight) camera, a stereo camera, a monocular camera, and an infrared camera, which are capable of measuring distance, can be applied to the camera 51 as necessary. The camera 51 is not limited to this, and the camera 51 may simply be used to acquire photographed images, regardless of distance measurement.

Further, for example, the external recognition sensor 25 can include an environmental sensor for detecting the environment of the vehicle 1. The environmental sensor is a sensor for detecting the environment such as weather, meteorology, brightness, and the like, and can include various sensors such as a raindrop sensor, a fog sensor, a sunlight sensor, a snow sensor, and an illuminance sensor.

Furthermore, for example, the external recognition sensor 25 includes a microphone to be used to detect sound around the vehicle 1, a position of a sound source, or the like.

The in-vehicle sensor 26 includes various sensors for detecting information inside the vehicle and supplies each unit of the vehicle control system 11 with sensor data from each sensor. The types and number of various sensors included in the in-vehicle sensor 26 are not particularly limited as long as they can be realistically installed in the vehicle 1.

For example, the in-vehicle sensor 26 can include one or more types of sensors among a camera, a radar, a seating sensor, a steering wheel sensor, a microphone, and a biological sensor. As the camera included in the in-vehicle sensor 26, it is possible to use cameras of various photographing methods capable of measuring distance, such as a ToF camera, a stereo camera, a monocular camera, and an infrared camera. However, the present invention is not limited to this, and the camera included in the in-vehicle sensor 26 may simply be used to acquire photographed images, regardless of distance measurement. The biosensor included in the in-vehicle sensor 26 is provided, for example, in a seat or a steering wheel, and detects various types of biological information of a passenger such as a driver.

The vehicle sensor 27 includes various sensors for detecting a state of the vehicle 1 and supplies each unit of the vehicle control system 11 with sensor data from each sensor. The types and number of various sensors included in the vehicle sensor 27 are not particularly limited as long as they can be realistically installed in the vehicle 1.

For example, the vehicle sensor 27 includes a velocity sensor, an acceleration sensor, an angular velocity sensor (gyroscope sensor), and an inertial measurement unit (IMU) that integrates these sensors. For example, the vehicle sensor 27 includes a steering angle sensor which detects a steering angle of the steering wheel, a yaw rate sensor, an accelerator sensor which detects an operation amount of the accelerator pedal, and a brake sensor which detects an operation amount of the brake pedal. For example, the vehicle sensor 27 includes a rotation sensor which detects a rotational speed of an engine or a motor, an air pressure sensor which detects air pressure of a tire, a slip ratio sensor which detects a slip ratio of a tire, and a wheel speed sensor which detects a rotational speed of a wheel. For example, the vehicle sensor 27 includes a battery sensor which detects remaining battery life and temperature of a battery and an impact sensor which detects an impact from the outside.

The storage unit 28 includes at least one of a nonvolatile storage medium and a volatile storage medium, and stores data and programs. The storage unit 28 is used, for example, as an EEPROM (Electrically Erasable Programmable Read Only Memory) and a RAM (Random Access Memory). A magnetic storage device such as an HDD (Hard Disc Drive), a semiconductor storage device, an optical storage device, and a magneto-optical storage device can be used as the storage medium. The storage unit 28 stores various programs and data used by each unit of the vehicle control system 11. For example, the storage unit 28 includes an EDR (Event Data Recorder) and a DSSAD (Data Storage System for Automated Driving), and stores information about the vehicle 1 before and after an event such as an accident and information acquired by the in-vehicle sensor 26.

The driving support/automated driving control unit 29 controls driving support and automated driving of the vehicle 1. For example, the driving support/automated driving control unit 29 includes an analyzing unit 61, an action planning unit 62, and an operation control unit 63.

The analyzing unit 61 performs analysis processing of the vehicle 1 and its surroundings. The analyzing unit 61 includes a self-position estimating unit 71, a sensor fusion unit 72, and the recognition unit 73.

The self-position estimating unit 71 estimates a self-position of the vehicle 1 based on sensor data from the external recognition sensor 25 and the high-precision map accumulated in the map information storage unit 23. For example, the self-position estimating unit 71 estimates a self-position of the vehicle 1 by generating a local map based on sensor data from the external recognition sensor 25 and matching the local map and the high precision map with each other. A position of the vehicle 1 is based on, for example, a center of the rear axle.

The local map is, for example, a three-dimensional high-precision map, an occupancy grid map, or the like created using a technique such as SLAM (Simultaneous Localization and Mapping). An example of a three-dimensional high-precision map is the point cloud map described above. An occupancy grid map is a map which is created by dividing a three-dimensional or two-dimensional space around the vehicle 1 into grids of a predetermined size and which indicates an occupancy of an object in grid units. The occupancy of an object is represented by, for example, a presence or an absence of the object or an existence probability of the object. The local map is also used in, for example, detection processing and recognition processing of surroundings of the vehicle 1 by the recognition unit 73.

Note that the self-position estimating unit 71 may estimate the self-position of the vehicle 1 based on the position information acquired by the position information acquisition unit 24 and sensor data from the vehicle sensor 27.

The sensor fusion unit 72 performs sensor fusion processing for obtaining new information by combining sensor data of a plurality of different types (for example, image data supplied from the camera 51 and sensor data supplied from the radar 52). Methods of combining sensor data of a plurality of different types include integration, fusion, and association.

The recognition unit 73 executes a detection process for detecting a situation outside the vehicle 1 and a recognition process for recognizing a situation outside the vehicle 1.

For example, the recognition unit 73 performs detection processing and recognition processing of surroundings of the vehicle 1 based on information from the external recognition sensor 25, information from the self-position estimating unit 71, information from the sensor fusion unit 72, and the like.

Specifically, for example, the recognition unit 73 performs detection processing, recognition processing, and the like of an object around the vehicle 1. The detection processing of an object refers to, for example, processing for detecting the presence or absence, a size, a shape, a position, a motion, or the like of an object. The recognition processing of an object refers to, for example, processing for recognizing an attribute such as a type of an object or identifying a specific object. However, a distinction between detection processing and recognition processing is not always obvious and an overlap may sometimes occur.

For example, the recognition unit 73 detects objects around the vehicle 1 by performing clustering to classify point clouds based on sensor data from the radar 52, the LiDAR 53, and the like for each cluster of point clouds. Accordingly, the presence or absence, a size, a shape, and a position of an object around the vehicle 1 are detected.

For example, the recognition unit 73 detects a motion of the object around the vehicle 1 by performing tracking to track a motion of a cluster of point clouds classified by clustering. Accordingly, a speed and traveling direction (a motion vector) of the object around the vehicle 1 are detected.

For example, the recognition unit 73 detects or recognizes vehicles, people, bicycles, obstacles, structures, roads, traffic lights, traffic signs, road markings, and the like based on the image data supplied from the camera 51. Further, the recognition unit 73 may recognize the types of objects around the vehicle 1 by performing recognition processing such as semantic segmentation.

For example, the recognition unit 73 can perform recognition processing of traffic rules around the vehicle 1 based on the map stored in the map information storage unit 23, the self-position estimation result obtained by the self-position estimating unit 71, and the recognition result of objects around the vehicle 1 obtained by the recognition unit 73. Through this processing, the recognition unit 73 can recognize the positions and states of traffic lights, the contents of traffic signs and road markings, the contents of traffic regulations, the lanes in which the vehicle can travel, and the like.

For example, the recognition unit 73 can perform recognition processing of the environment around the vehicle 1. The surrounding environment to be recognized by the recognition unit 73 includes weather, temperature, humidity, brightness, road surface conditions, and the like.

The action planning unit 62 creates an action plan of the vehicle 1. For example, the action planning unit 62 creates an action plan by performing processing of path planning and path following.

Path planning (Global path planning) is processing of planning a general path from start to goal. Path planning also includes processing of trajectory generation (local path planning) which is referred to as trajectory planning and which enables safe and smooth travel in the vicinity of the vehicle 1 in consideration of motion characteristics of the vehicle 1 along a planned path.

Path following refers to processing of planning an operation for safely and accurately traveling the path planned by path planning within a planned time. The action planning unit 62 can calculate the target speed and target angular velocity of the vehicle 1, for example, based on the result of this route following process.

The operation control unit 63 controls operations of the vehicle 1 in order to realize the action plan created by the action planning unit 62.

For example, the operation control unit 63 controls a steering control unit 81, a brake control unit 82, and a drive control unit 83, which are included in a vehicle control unit 32 described later, to perform acceleration/deceleration control and directional control so that the vehicle 1 proceeds along a trajectory calculated by trajectory planning. For example, the operation control unit 63 performs cooperative control in order to realize functions of ADAS such as collision avoidance or shock mitigation, car-following driving, constant-speed driving, collision warning of own vehicle, and lane deviation warning of own vehicle. For example, the operation control unit 63 performs cooperative control in order to realize automated driving or the like in which a vehicle autonomously travels irrespective of manipulations by a driver.

The DMS 30 performs authentication processing of a driver, recognition processing of a state of the driver, and the like based on sensor data from the in-vehicle sensor 26, input data that is input to the HMI 31 described later, and the like. As a state of the driver to be a recognition target, for example, a physical condition, a level of arousal, a level of concentration, a level of fatigue, an eye gaze direction, a level of intoxication, a driving operation, or a posture is assumed.

Alternatively, the DMS 30 may be configured to perform authentication processing of an occupant other than the driver and recognition processing of a state of such an occupant. In addition, for example, the DMS 30 may be configured to perform recognition processing of a situation inside the vehicle based on sensor data from the in-vehicle sensor 26. As the situation inside the vehicle to be a recognition target, for example, temperature, humidity, brightness, or odor is assumed.

The HMI 31 inputs various pieces of data and instructions, and presents various pieces of data to the driver and the like.

Data input by the HMI 31 will be briefly described. The HMI 31 includes an input device for a person to input data. The HMI 31 generates input signals based on data, instructions, and the like input by an input device, and supplies them to each unit of the vehicle control system 11. The HMI 31 includes operators such as a touch panel, buttons, switches, and levers as input devices. However, the present invention is not limited to this, and the HMI 31 may further include an input device capable of inputting information by a method other than manual operation using voice, gesture, or the like. Further, the HMI 31 may use, as an input device, an externally connected device such as a remote control device using infrared rays or radio waves, a mobile device or a wearable device compatible with the operation of the vehicle control system 11, for example.

Presentation of data by the HMI 31 will be briefly described. The HMI 31 generates visual information, auditory information, and tactile information for the passenger or the outside of the vehicle. Furthermore, the HMI 31 performs output control to control the output, output content, output timing, output method, and the like of each piece of generated information. The HMI 31 generates and outputs, as visual information, information indicated by images and light, such as an operation screen, a status display of the vehicle 1, a warning display, and a monitor image showing the surrounding situation of the vehicle 1, for example. Furthermore, the HMI 31 generates and outputs, as auditory information, information indicated by sounds such as audio guidance, warning sounds, and warning messages. Furthermore, the HMI 31 generates and outputs, as tactile information, information given to the passenger's tactile sense by, for example, force, vibration, movement, or the like.

As an output device for the HMI 31 to output visual information, for example, a display device that presents visual information by displaying an image or a projector device that presents visual information by projecting an image can be applied. In addition to display devices that have a normal display, the display device may be a display device that displays visual information within the passenger's field of view such as, for example, a head-up display, a transparent display, and a wearable device with an AR (Augmented Reality) function. Further, the HMI 31 can also use a display device included in a navigation device, an instrument panel, a CMS (Camera Monitoring System), an electronic mirror, a lamp, and the like provided in the vehicle 1 as an output device that outputs visual information.

As an output device for the HMI 31 to output auditory information, for example, an audio speaker, headphones, or earphones can be applied.

As an output device for the HMI 31 to output tactile information, for example, a haptics element using a haptics technology can be applied. The haptics element is provided in a portion of the vehicle 1 that comes into contact with a passenger, such as a steering wheel or a seat.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like of a state of a steering system of the vehicle 1. The steering system includes, for example, a steering mechanism including the steering wheel and the like, electronic power steering, and the like. For example, the steering control unit 81 includes a steering ECU which controls the steering system, an actuator which drives the steering system, and the like.

The brake control unit 82 performs detection, control, and the like of a state of a brake system of the vehicle 1. For example, the brake system includes a brake mechanism including a brake pedal and the like, an ABS (Antilock Brake System), a regenerative brake mechanism, and the like. For example, the brake control unit 82 includes a brake ECU which controls the brake system, an actuator which drives the brake system, and the like.

The drive control unit 83 performs detection, control, and the like of a state of a drive system of the vehicle 1. For example, the drive system includes an accelerator pedal, a drive force generating device for generating a drive force such as an internal combustion engine or a drive motor, a drive force transmission mechanism for transmitting the drive force to the wheels, and the like. For example, the drive control unit 83 includes a drive ECU which controls the drive system, an actuator which drives the drive system, and the like.

The body system control unit 84 performs detection, control, and the like of a state of a body system of the vehicle 1. For example, the body system includes a keyless entry system, a smart key system, a power window device, a power seat, an air conditioner, an airbag, a seatbelt, and a shift lever. For example, the body system control unit 84 includes a body system ECU which controls the body system, an actuator which drives the body system, and the like.

The light control unit 85 performs detection, control, and the like of a state of various lights of the vehicle 1. As lights to be a control target, for example, a headlamp, a tail lamp, a fog lamp, a turn signal, a brake lamp, a projector lamp, and a bumper display are assumed. The light control unit 85 includes a light ECU which controls the lights, an actuator which drives the lights, and the like.

The horn control unit 86 performs detection, control, and the like of a state of a car horn of the vehicle 1. For example, the horn control unit 86 includes a horn ECU which controls the car horn, an actuator which drives the car horn, and the like.

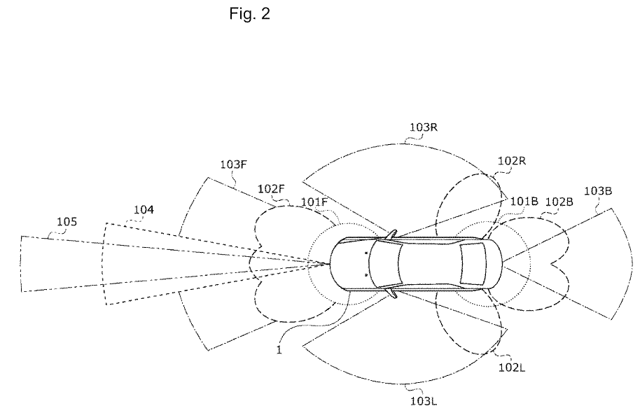

FIG. 2 is a diagram showing an example of a sensing region by the camera 51, the radar 52, the LiDAR 53, the ultrasonic sensor 54, and the like of the external recognition sensor 25 in FIG. 1. Note that FIG. 2 schematically shows the vehicle 1 viewed from above, with the left end side being the front end (front) side of the vehicle 1, and the right end side being the rear end (rear) side of the vehicle 1.

A sensing region 101F and a sensing region 101B represent an example of sensing regions of the ultrasonic sensor 54. The sensing region 101F covers the region around the front end of the vehicle 1 by a plurality of ultrasonic sensors 54. The sensing region 101B covers the region around the rear end of the vehicle 1 by a plurality of ultrasonic sensors 54.

Sensing results in the sensing region 101F and the sensing region 101B are used to provide the vehicle 1 with parking assistance or the like.

A sensing region 102F to a sensing region 102B represent an example of sensing regions of the radar 52 for short or intermediate distances. The sensing region 102F covers up to a position farther than the sensing region 101F in front of the vehicle 1. The sensing region 102B covers up to a position farther than the sensing region 101B to the rear of the vehicle 1. The sensing region 102L covers a periphery toward the rear of a left-side surface of the vehicle 1. The sensing region 102R covers a periphery toward the rear of a right-side surface of the vehicle 1.

A sensing result in the sensing region 102F is used to detect, for example, a vehicle, a pedestrian, or the like present in front of the vehicle 1. A sensing result in the sensing region 102B is used by, for example, a function of preventing a collision to the rear of the vehicle 1. Sensing results in the sensing region 102L and the sensing region 102R are used to detect, for example, an object present in a blind spot to the sides of the vehicle 1.

A sensing region 103F to a sensing region 103B represent an example of sensing regions by the camera 51. The sensing region 103F covers up to a position farther than the sensing region 102F in front of the vehicle 1. The sensing region 103B covers a position farther than the sensing region 102B behind the vehicle 1. The sensing region 103L covers a periphery of the left-side surface of the vehicle 1. The sensing region 103R covers a periphery of the right-side surface of the vehicle 1.

The sensing results in the sensing region 103F can be used, for example, for recognition of traffic lights and traffic signs, lane departure prevention support systems, and automatic headlight control systems. The sensing results in the sensing region 103B can be used, for example, in parking assistance and surround-view systems. The sensing results in the sensing region 103L and the sensing region 103R can be used, for example, in surround-view systems.

A sensing region 104 represents an example of a sensing region of the LiDAR 53. The sensing region 104 covers up to a position farther than the sensing region 103F in front of the vehicle 1. On the other hand, the sensing region 104 has a narrower range in a left-right direction than the sensing region 103F.

Sensing results in the sensing region 104 are used, for example, to detect objects such as nearby vehicles.

A sensing region 105 represents an example of a sensing region of the radar 52 for long distances. The sensing region 105 covers up to a position farther than the sensing region 104 in front of the vehicle 1. On the other hand, the sensing region 105 has a narrower range in the left-right direction than the sensing region 104.

The sensing results in the sensing region 105 are used, for example, for ACC (Adaptive Cruise Control), emergency braking, collision avoidance, and the like.

Note that the sensing regions of the cameras 51, the radar 52, the LiDAR 53, and the ultrasonic sensors 54 included in the external recognition sensor 25 may have various configurations other than those shown in FIG. 2. Specifically, the ultrasonic sensor 54 may be configured to sense the sides of the vehicle 1 or the LiDAR 53 may be configured to sense the rear of the vehicle 1. Moreover, the installation position of each sensor is not limited to each example mentioned above. Further, the number of sensors may be one or more than one.

The present technology can be applied to the LiDAR 53, for example.

### 2. Embodiment

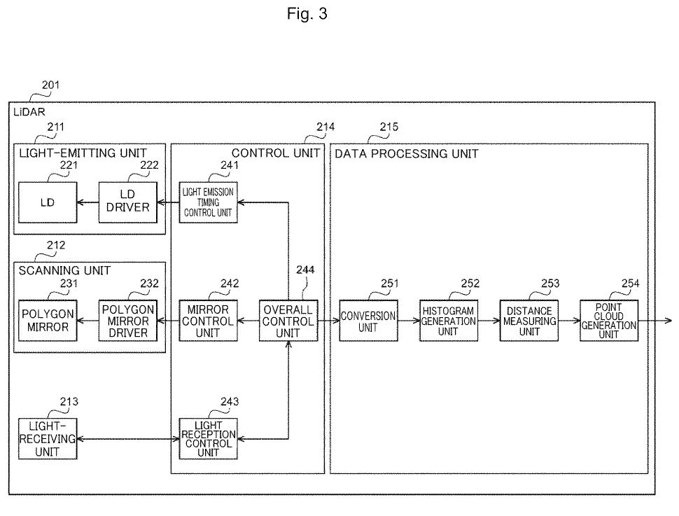

Next, embodiments of the present technology will be described with reference to FIGS. 3 to 13.

### Configuration Example of LiDAR 211

FIG. 3 shows an embodiment of the LiDAR 211 to which the present technology is applied.

The LiDAR 211 is configured by, for example, a dToF (Direct Time of Flight) LiDAR. The LiDAR 211 includes a light-emitting unit 211, a scanning unit 212, a light-receiving unit 213, a control unit 214, and a data processing unit 215. The light-emitting unit 211 includes an LD (Laser Diode) 221 and an LD driver 222. The scanning unit 212 includes a polygon mirror 231 and a polygon mirror driver 232. The control unit 214 includes a light emission timing control unit 241, a mirror control unit 242, a light reception control unit 243, and an overall control unit 244. The data processing unit 215 includes a conversion unit 251, a histogram generation unit 252, a distance measuring unit 253, and a point cloud generation unit 254.

The LD 221 emits pulsed laser light (hereinafter referred to as irradiation light) under the control of the LD driver 222.

The LD driver 222 drives the LD 221 in units of predetermined time Δt under the control of the light emission timing control unit 241.

The polygon mirror 231 reflects the irradiation light incident from the LD 221 while rotating around a predetermined axis under the control of the polygon mirror driver 232. As a result, the irradiation light is scanned in the left-right direction (horizontal direction).

Here, the coordinate system of a LiDAR 201 (hereinafter referred to as a LiDAR coordinate system) is defined by, for example, an X axis, a Y axis, and a Z axis that are orthogonal to each other. The X-axis is, for example, an axis parallel to the left-right direction (horizontal direction) of the LiDAR 211. Therefore, the scanning direction of the irradiation light is the X-axis direction. The Y-axis is, for example, an axis parallel to the up-down direction (vertical direction) of the LiDAR 11. The Z-axis is, for example, an axis parallel to the front-rear direction (depth direction, distance direction) of the LiDAR 211.

The polygon mirror driver 232 drives the polygon mirror 231 under the control of the mirror control unit 242.

The light-receiving unit 213 includes, for example, a pixel array unit in which pixels in which SPADs (Single Photon Avalanche Diodes) are arranged two-dimensionally are arranged in a predetermined direction.

Here, the coordinate system of the pixel array unit of the light-receiving unit 213 is defined by, for example, the x-axis and the y-axis. The x-axis direction is a direction corresponding to the X-axis direction of the LiDAR coordinate system, and the y-axis direction is a direction corresponding to the Y-axis direction of the LiDAR coordinate system. In the pixel array unit, pixels are arranged in the y-axis direction.

Each pixel of the light-receiving unit 213 receives incident light including reflected light obtained by reflecting the irradiation light from an object under the control of the light reception control unit 243. The light-receiving unit 213 supplies a pixel signal indicating the intensity of the incident light received by each pixel to the light reception control unit 243.

The light emission timing control unit 241 controls the LD driver 222 under the control of the overall control unit 244, and controls the light emission timing of the LD 221.

The mirror control unit 242 controls the polygon mirror driver 232 under the control of the overall control unit 244, and controls the scanning of the irradiation light by the polygon mirror 231.

The light reception control unit 243 drives the light-receiving unit 213. The light reception control unit 243 supplies the pixel signal of each pixel supplied from the light-receiving unit 213 to the overall control unit 244.

The overall control unit 244 controls the light emission timing control unit 241, the mirror control unit 242, and the light reception control unit 243. Further, the overall control unit 244 supplies the pixel signal supplied from the light reception control unit 243 to the conversion unit 251.

The conversion unit 251 converts the pixel signal supplied from the overall control unit 244 into a digital signal and supplies it to the histogram generation unit 252.

The histogram generation unit 252 generates a histogram indicating a time-series distribution of the intensity of incident light from each predetermined unit field of view. The histogram of each unit field of view shows, for example, a time-series distribution of the intensity of incident light from each unit field of view from the time point when the irradiation light for each unit field of view is emitted.

Here, the position of each unit field of view is defined by the position in the X-axis direction and Y-axis direction of the LiDAR coordinate system.

For example, the irradiation light is scanned within a predetermined range (hereinafter referred to as a scanning range) in the X-axis direction. Then, distance measurement processing is performed for each unit field of view having a predetermined viewing angle Δθ in the X-axis direction. For example, if the scanning range of the irradiation light is within the range of −60° to 60° and the viewing angle of the unit field of view is 0.2°, the number of unit fields of view in the X-axis direction is 600 (120°÷0.2°). The viewing angle in the X-axis direction of the unit field of view becomes the resolution of the LiDAR 211 in the X-axis direction.

Each pixel of the pixel array unit of the light-receiving unit 213 receives reflected light from different unit fields of view in the Y-axis direction, for example. Therefore, the number of unit fields of view in the Y-axis direction is equal to the number of pixels in the pixel array unit of the light-receiving unit 213 in the y-axis direction. For example, when the number of pixels in the y-axis direction of the pixel array unit is 64, the number of unit fields of view in the Y-axis direction is 64. The viewing angle of the unit field of view in the Y-axis direction becomes the resolution of the LiDAR 211 in the Y-axis direction.

In this way, the irradiation range of the irradiation light is divided into unit fields of view arranged two-dimensionally in the X-axis direction and the Y-axis direction. Then, distance measurement processing is performed for each unit field of view.

The histogram generation unit 252 supplies histogram data corresponding to each unit field of view to the distance measuring unit 253.

The distance measuring unit 253 measures the distance (depth) in the Z-axis direction to the reflection point of the irradiation light in each unit field of view based on the histogram of each unit field of view. For example, the distance measuring unit 253 creates an approximate curve of a histogram and detects the peak of the approximate curve. The time when this approximate curve reaches its peak is the time from when the irradiation light is emitted to when the reflected light is received. The distance measuring unit 253 converts the time at which the approximate curve of each histogram reaches a peak into the distance to the reflection point where the irradiation light is reflected. The distance measuring unit 253 supplies information indicating the distance to the reflection point within each unit field of view to the point cloud generation unit 254.

The point cloud generation unit 254 generates a point cloud (point cloud data) indicating the distribution of each reflection point in the LiDAR coordinate system based on the distance to the reflection point within each unit field of view. The point cloud generation unit 254 outputs data indicating the generated point cloud to a subsequent device.

### Example of Channel Configuration of LD 221

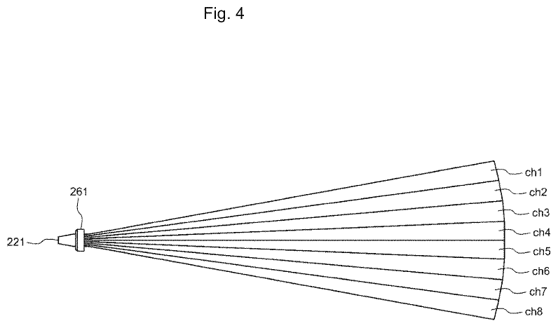

Next, an example of the channel configuration of the LD 221 will be described with reference to FIG. 4.

In the LD 211, light-emitting regions capable of individually emitting eight channels of irradiation light from ch1 to ch8 are arranged in a direction corresponding to the Y-axis direction of the LiDAR coordinate system. The LD 211 is capable of individually emitting irradiation light of each channel. That is, the LD 211 can emit the irradiation light of each channel at different timings, or can emit the irradiation light of a plurality of channels simultaneously.

The irradiation light of each channel emitted from the LD 211 is spread by a projection lens 261 in a direction corresponding to the Y-axis direction of the LiDAR coordinate system, and becomes elongated light. Further, the irradiation light of each channel is arranged in a direction corresponding to the Y-axis direction of the LiDAR coordinate system.

### Configuration Example of Optical System of LiDAR 201

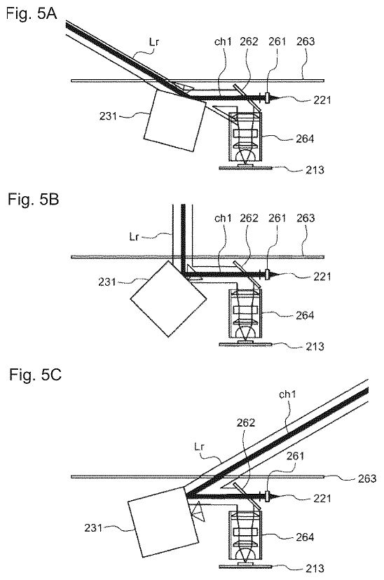

Next, a configuration example of the optical system of the LiDAR 201 will be described with reference to FIG. 5. FIG. 5 is a plan view of the LiDAR optical system. A in FIG. 5 shows the case where the direction of the irradiated light is 30°, B in FIG. 5 shows the case where the direction of the irradiated light is 90°, and C in FIG. 5 shows the case where the direction of the irradiated light is 150°. The direction of the irradiated light in this case is expressed by the angle of the output direction with respect to the incident direction of the irradiated light to the polygon mirror 231.

The LiDAR 201 includes a folding mirror 262, an exterior window 263, and a light-receiving lens 264 in addition to the configuration described above with reference to FIGS. 3 and 4.

The irradiation light of each channel (in the figure, only the irradiation light of ch1 is shown) that is emitted from the LD 211 and elongated by the projection lens 261 is reflected by the polygon mirror 231, passes through the exterior window 263, and is irradiated onto a predetermined irradiation range. At this time, by rotating the polygon mirror 231 in the X-axis direction about a predetermined rotation axis, the irradiation light of each channel is scanned in the X-axis direction.

Further, when the irradiation light of each channel is emitted simultaneously, the irradiation range of the irradiation light of each channel has approximately the same position in the X-axis direction and continues in the Y-axis direction. That is, the irradiation ranges of the irradiation light of ch1 and the irradiation light of ch2 are adjacent to each other in the Y-axis direction, the irradiation ranges of the irradiation light of ch2 and the irradiation light of ch3 are adjacent to each other in the Y-axis direction, the irradiation ranges of the irradiation light of ch3 and the irradiation light of ch4 are adjacent to each other in the Y-axis direction, the irradiation ranges of the irradiation light of ch4 and the irradiation light of ch5 are adjacent to each other in the Y-axis direction, the irradiation ranges of the irradiation light of ch5 and the irradiation light of ch6 are adjacent to each other in the Y-axis direction, the irradiation ranges of the irradiation light of ch6 and the irradiation light of ch7 are adjacent to each other in the Y-axis direction, and the irradiation ranges of the irradiation light of ch7 and the irradiation light of ch8 are adjacent to each other in the Y-axis direction.

The irradiation light of each channel is reflected by an object, and the incident light including the reflected light Lr passes through the exterior window 263, enters the polygon mirror 231, and is reflected in the direction opposite to the irradiation light of each channel. Thereafter, the incident light passes through the folding mirror 262, is condensed by the light-receiving lens 264, and enters the pixel array unit of the light-receiving unit 213.

In the pixel array unit of the light-receiving unit 213, for example, a plurality of pixels are arranged for each channel. For example, in the pixel array unit, eight pixels are arranged in the y-axis direction for each channel. Therefore, a total of sixty four pixels are arranged in the y-axis direction in the pixel array unit, and the number of unit fields of view in the Y-axis direction is 64. The incident light including the reflected light of the irradiation light of each channel is incident on the pixel group of the corresponding channel.

### First Embodiment of Irradiation Light Control Method

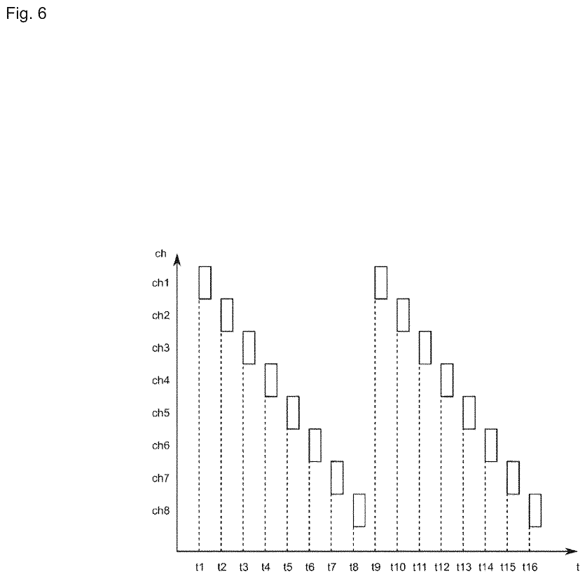

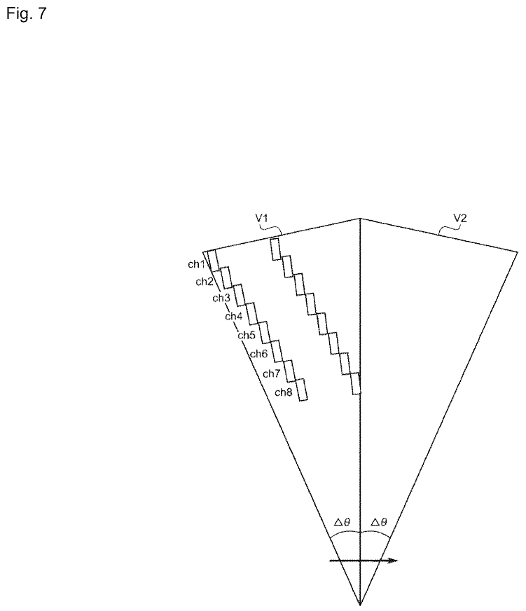

Next, a first embodiment of a method for controlling irradiation light of each channel of the LD 211 will be described with reference to FIGS. 6 and 7.

FIG. 6 is a graph showing an example of the emission timing of the irradiation light of each channel. The horizontal axis shows time, and the vertical axis shows channels. FIG. 7 schematically shows an example of the irradiation direction of the irradiation light of each channel.

The irradiation light of each channel is emitted a predetermined number of times for each unit field of view in the X-axis direction. In other words, the irradiation light of each channel is emitted a predetermined number of times every time the irradiation light is scanned in the X-axis direction by a predetermined viewing angle Δθ.

For example, as shown in FIG. 7, the irradiation lights of ch1 to ch8 are emitted twice within the unit field of view V1 of the viewing angle Δθ, and the irradiation lights of ch1 to ch8 are emitted twice within the unit field of view V2 of the viewing angle Δθ.

Then, the distance in each unit field of view in the Y-axis direction is measured for each unit field of view in the X-axis direction. For example, distances in 64 unit fields of view in the Y-axis direction are measured in the unit field of view V1, and distances in 64 unit fields of view in the Y-axis direction are measured in the unit field of view V2.

In this example, within the unit field of view in the X-axis direction, the step of emitting irradiation light in channel order at time intervals Δt is repeated twice. Specifically, the irradiation light of ch1 is emitted at time t1, the irradiation light of ch2 is emitted at time t2, the irradiation light of ch3 is emitted at time t3, the irradiation light of ch4 is emitted at time t4, the irradiation light of ch5 is emitted at time t5, the irradiation light of ch6 is emitted at time t6, the irradiation light of ch7 is emitted at time t7, and the irradiation light of ch8 is emitted at time t8. Next, the irradiation light of ch1 is emitted at time t9, the irradiation light of ch2 is emitted at time t10, the irradiation light of ch3 is emitted at time t11, the irradiation light of ch4 is emitted at time t12, the irradiation light of ch5 is emitted at time t13, the irradiation light of ch6 is emitted at time t14, the irradiation light of ch7 is emitted at time t15, and the irradiation light of ch8 is emitted at time t16.

Then, for each channel, the intensity of the incident light including the reflected light for the first irradiation light and the intensity of the incident light including the reflected light for the second irradiation light are integrated, and distance measurement is performed based on the integrated intensity of the incident light.

Therefore, for example, the emission interval of the irradiation light of ch1 is time t9−time t1=8Δt. The emission intervals of the irradiation lights of other channels are also 8Δt.

The longer the emission interval of the irradiation lights from each channel, the greater the deviation between the first and second irradiation directions of the irradiation light from each channel. As a result, for example, the first irradiation light and the second irradiation light may be reflected by different objects, making it impossible to measure distance and reducing the resolution in the X-axis direction. Therefore, it is desirable to shorten the emission interval of the irradiation light of each channel within each unit field of view in the X-axis direction.

Note that hereinafter, the period of Δt that defines the emission timing of the irradiation light will be referred to as a slot. Therefore, in this example, sixteen slots are provided for each unit field of view in the X-axis direction.

### Second Embodiment of Irradiation Light Control Method

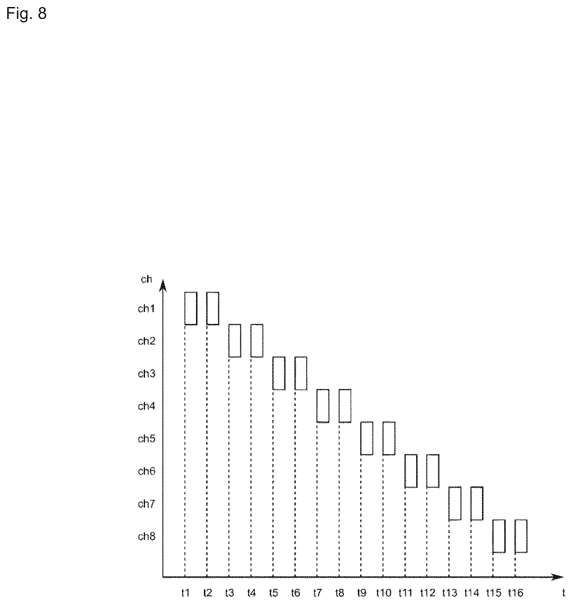

Next, with reference to FIG. 8, a second embodiment of a method for controlling irradiation light of each channel of the LD 211 will be described.

Similarly to FIG. 6, FIG. 8 is a graph showing an example of the emission timing of the irradiation light of each channel.

In this example, the irradiation light of each channel is continuously emitted within a unit field of view in the X-axis direction. Specifically, at time t1 and time t2, the irradiation light of ch1 is continuously emitted. At time t3 and time t4, the irradiation light of ch2 is continuously emitted. At time t5 and time t6, the irradiation light of ch3 is continuously emitted. At time t7 and time t8, the irradiation light of ch4 is continuously emitted. At time t9 and time t10, the irradiation light of ch5 is continuously emitted. At time t11 and time t12, the irradiation light of ch6 is continuously emitted. At time t13 and time t14, the irradiation light of ch7 is continuously emitted. At time t15 and time t16, the irradiation light of ch8 is continuously emitted.

As a result, the emission interval of the irradiation light of each channel can be shortened to Δt, and a decrease in resolution in the X-axis direction can be suppressed.

Note that in this case, the emission interval of the irradiation light between channels becomes large. For example, the emission interval between the second irradiation light of ch1 and the first irradiation light of ch8 is time t15−time t2=13Δt. However, since this difference in emission timing between channels is known, for example, the influence of differences in emission timing between channels is eliminated by correcting the position of the point in the X-axis direction for each channel based on the emission interval between channels when generating a point cloud.

### Third Embodiment of Irradiation Light Control Method

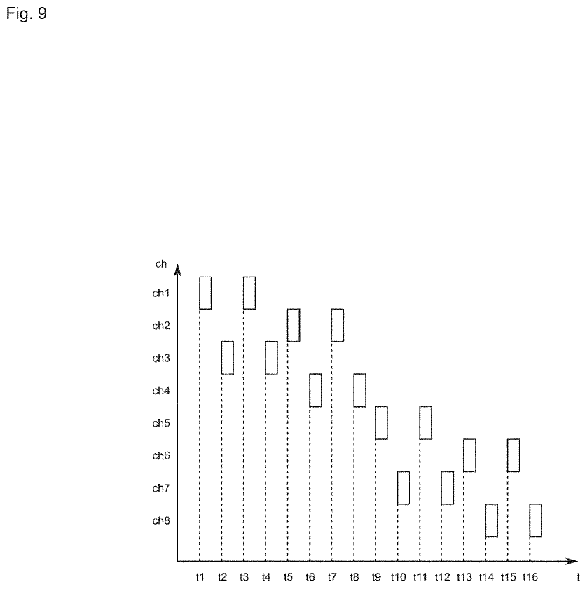

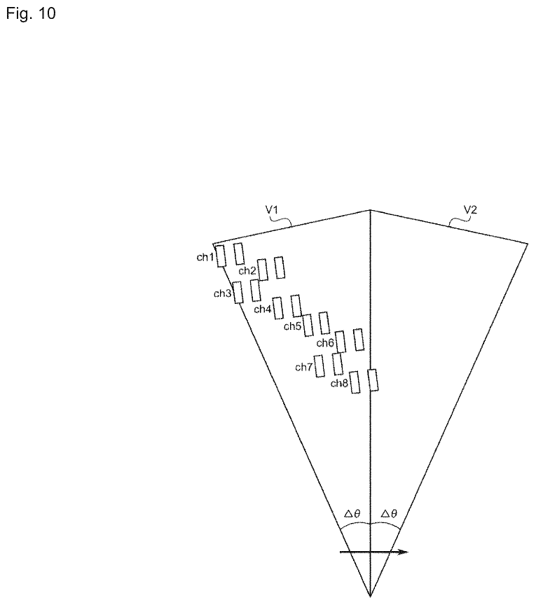

Next, a third embodiment of a method for controlling irradiation light of each channel of the LD 211 will be described with reference to FIGS. 9 and 10.

Similarly to FIG. 6, FIG. 9 is a graph showing an example of the emission timing of the irradiation light of each channel. Similarly to FIG. 7, FIG. 10 schematically shows an example of the irradiation direction of the irradiation light of each channel.

In the second embodiment described above with reference to FIG. 8, the irradiation light of each channel is continuously emitted. Further, the irradiation lights of adjacent channels are continuously emitted. For example, the irradiation light of ch1 and the irradiation light of ch2 are continuously emitted. Therefore, the irradiation light may be emitted and concentrated within a narrow range. This increases the possibility that the intensity of the irradiation light per time will be limited due to the restrictions of laser light safety standards.

On the other hand, as shown in FIGS. 9 and 10, for example, the emission timing of the irradiation light of each channel is controlled.

Specifically, at time t1 and time t3, the irradiation light of ch1 is emitted. At time t2 and time t4, the irradiation light of ch3 is emitted. At time t5 and time t7, the irradiation light of ch2 is emitted. At time t6 and time t8, the irradiation light of ch4 is emitted. At time t9 and time t11, the irradiation light of ch5 is emitted. At time t10 and time t12, the irradiation light of ch7 is emitted. At time t13 and time t15, the irradiation light of ch6 is emitted. At time t14 and time t16, the irradiation light of ch8 is emitted.

As a result, compared to the example of FIG. 6, the emission interval of the irradiation light of each channel can be shortened to 2Δt, and a decrease in resolution in the X-axis direction can be suppressed.

Furthermore, compared to the example of FIG. 8, the emission interval of the irradiation light of each channel is extended to 2Δt. Furthermore, successive irradiation of irradiation lights of adjacent channels is prevented. As a result, the irradiation light is prevented from being emitted and concentrated in a narrow range, and the possibility that the intensity of the irradiation light per time is limited due to the restrictions of laser light safety standards can be reduced.

In addition, in the case of this example, strictly speaking, the irradiation lights of adjacent channels are irradiated continuously between time t4 and time t5, between time t8 and time t9, and between time t12 and time t13.

On the other hand, the interval between the times when the irradiation lights of adjacent channels are continuously irradiated (for example, between time t4 and time t5) may be set to be longer than the interval between the times when the irradiation lights of adjacent channels are continuously irradiated (for example, between time t1 and time t2).

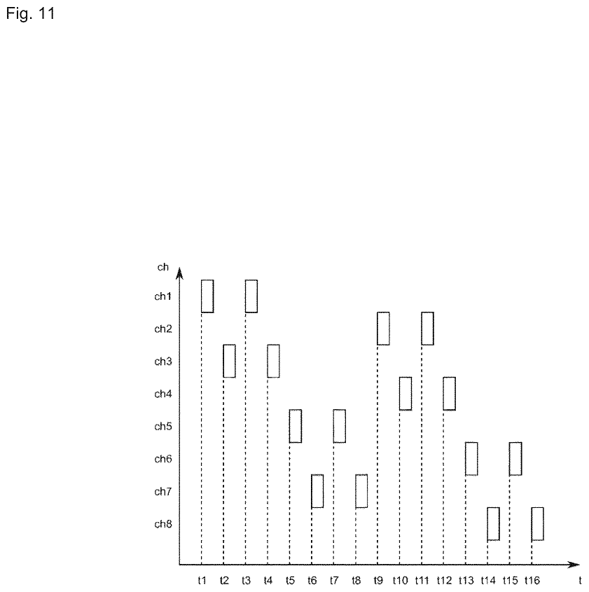

Further, for example, the emission timing of the irradiation light of each channel may be changed as shown in FIG. 11.

Specifically, at time t1 and time t3, the irradiation light of ch1 is emitted. At time t2 and time t4, the irradiation light of ch3 is emitted. At time t5 and time t7, the irradiation light of ch5 is emitted. At time t6 and time t8, the irradiation light of ch7 is emitted. At time t9 and time t11, the irradiation light of ch2 is emitted. At time t10 and time t12, the irradiation light of ch4 is emitted. At time t13 and time t15, the irradiation light of ch6 is emitted. At time t14 and time t16, the irradiation light of ch8 is emitted.

This completely prevents successive irradiation of irradiation lights of adjacent channels.

### Fourth Embodiment of Irradiation Light Control Method

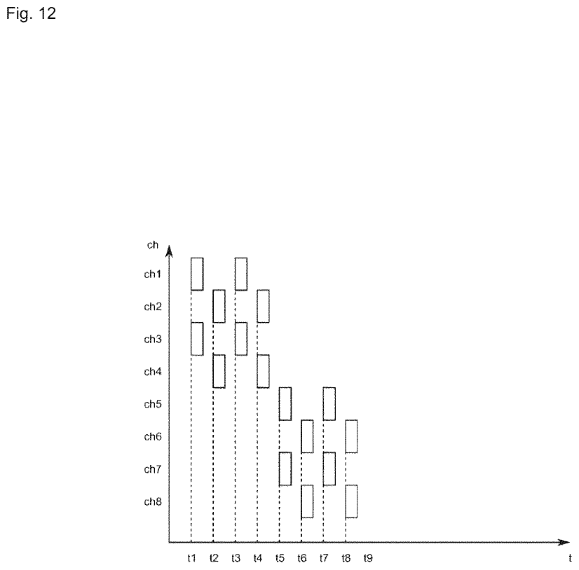

Next, a fourth embodiment of a method for controlling irradiation light will be described with reference to FIG. 12.

Similarly to FIG. 6, FIG. 12 shows an example of the emission timing of the irradiation light of each channel.

Specifically, at time t1 and time t3, the irradiation lights of ch1 and ch3 are emitted. At time t2 and time t4, the irradiation lights of ch2 and ch4 are emitted. At time t5 and time t7, the irradiation lights of ch5 and ch7 are emitted. At time t6 and time t8, the irradiation lights of ch6 and ch8 are emitted.

In this way, irradiation lights of two channels that are not adjacent to each other are emitted simultaneously. Further, similarly to the third embodiment, the emission interval of the irradiation lights of the same channel is set to 2Δt.

As in the third embodiment, this prevents the irradiation light from being emitted and concentrated in a narrow range while suppressing a decrease in the resolution in the X-axis direction.

Further, the time required for emitting irradiation light from all channels within a unit field of view in the X-axis direction can be shortened. This makes it possible, for example, to narrow the viewing angle of the unit field of view and increase the resolution in the X-axis direction. Alternatively, for example, it becomes possible to increase the frame rate by increasing the scanning speed in the X-axis direction.

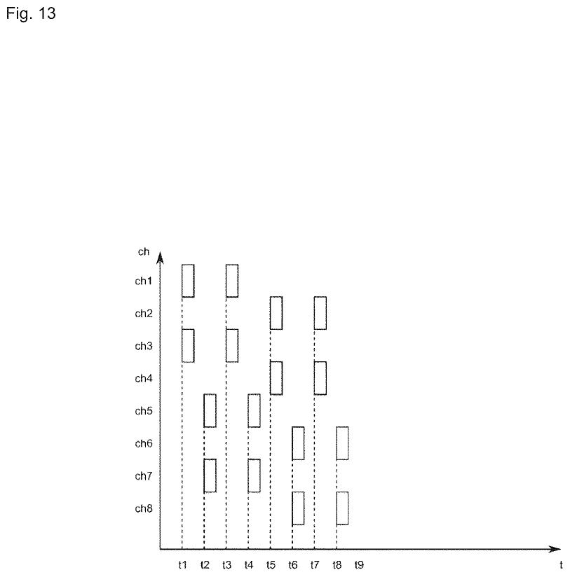

Note that, for example, the emission timing of the irradiation light of each channel may be changed as shown in FIG. 13.

Specifically, at time t1 and time t3, the irradiation lights of ch1 and ch3 are emitted. At time t2 and time t4, the irradiation lights of ch5 and ch7 are emitted. At time t5 and time t7, the irradiation lights of ch2 and ch4 are emitted. At time t6 and time t8, the irradiation lights of ch6 and ch8 are emitted.

As a result, compared to the example of FIG. 12, successive irradiation of irradiation lights of adjacent channels is suppressed.

### 3. Modification Examples

Hereinafter, modification examples of the foregoing embodiments of the present technique will be described.

The number of channels of the LD 221 can be changed as appropriate. However, the effects of the present technology can be achieved only when there are four or more channels.

In the third embodiment and the fourth embodiment of the irradiation light control method, an example has been shown in which the emission interval of the irradiation light of the same channel is set to 2Δt, but the emission interval may also be set to a value other than 2Δt.

For example, when the number of channels of the LD 221 is n channels, by setting the emission interval of the irradiation light of each channel shorter than nΔt, the emission interval of the irradiation light of each channel can be shortened compared to the example of FIG. 6. Further, for example, by setting the emission interval of the irradiation light of each channel to 2Δt or more, the irradiation light of each channel is prevented from being emitted in a concentrated manner compared to the example of FIG. 8. That is, in the present technology, by setting the emission interval of the irradiation light of each channel to 2Δt or more and less than nΔt, it is possible to achieve the effect of shortening the emission interval of the irradiation light of each channel while preventing the irradiation light of each channel from being emitted in a concentrated manner.

The present technique can also be applied to the case where the irradiation light of each channel is emitted m times, which is three or more times, within a unit field of view. In this case, for example, in each embodiment, the same emission method as the emission method up to the second irradiation light of each channel may be repeatedly performed.

For example, in the second embodiment described above with reference to FIG. 8, the irradiation light of each channel may be continuously emitted m times. For example, in the third embodiment described above with reference to FIGS. 9 to 11 and the fourth embodiment described above with reference to FIGS. 12 and 13, the irradiation light of each channel may be emitted m times every other slot.

In the third embodiment, an example has been shown in which the channel of the irradiation light emitted in the next slot (output timing) is set to a channel two channels away from the channel of the irradiation light emitted in the previous slot (output timing). For example, an example has been shown in which the irradiation light of ch1 is emitted at time t1, and then the irradiation light of ch3, which is two channels away from ch1, is emitted at time t2. On the other hand, for example, the irradiation light of a channel that is three or more channels away from the channel of the irradiation light emitted in the previous slot may be emitted.

In the fourth embodiment, an example has been shown in which the interval between channels of irradiation lights emitted simultaneously is two channels. For example, an example has been shown in which, at time t1, the irradiation lights of ch1 and ch3, which is two channels away from ch1, are simultaneously emitted. On the other hand, for example, the irradiation lights of channels separated from each other by three channels or more may be emitted.

For example, in the fourth embodiment, irradiation lights of three or more channels that are not adjacent to each other may be emitted simultaneously.

In the above description, an example has been shown in which a plurality of light-emitting regions that emit irradiation light are provided by dividing the LD into a plurality of channels, but a plurality of light-emitting regions may be provided using other methods. For example, a plurality of light-emitting regions may be provided using a plurality of LDs that can be driven individually.

The present technology can also be applied, for example, when using a light source other than an LD.

For example, it is possible to use an APD (avalanche photodiode), a highly sensitive photodiode, or the like as the light-receiving element of the pixel array unit 213A.

The method of scanning the irradiation light is not limited to the example described above, and other methods can also be applied. For example, the irradiation light may be scanned using a rotating mirror, a galvano mirror, a Risley prism, an MMT (Micro Motion Technology), a head spin, a MEMS (Micro-Electro-Mechanical Systems) mirror, an OPA (Optical Phased Array), a liquid crystal, a VCSEL (Vertical Cavity Surface Emitting Laser) array scan, and the like.

For example, the irradiation light may be shaped to extend in the X-axis direction, and the irradiation light may be scanned in the Y-axis direction.

In addition to LiDAR, the present technology can be applied to a distance measuring device that scans irradiated light emitted from a plurality of light-emitting regions and measures a distance based on incident light including reflected light of the irradiated light.

### 4. Others

### Configuration Example of Computer

The series of processing described above can be executed by hardware or can be executed by software. When the series of steps of processing is performed by software, a program of the software is installed in a computer. Here, the computer includes a computer embedded in dedicated hardware or, for example, a general-purpose personal computer capable of executing various functions by installing various programs.

A program executed by a computer can be provided by being recorded on a removable medium such as a package medium, for example. The program can also be provided via a wired or wireless transmission medium such as a local area network, the Internet, or digital satellite broadcasting.

Note that the program executed by a computer may be a program that performs processing chronologically in the order described in the present specification or may be a program that performs processing in parallel or at a necessary timing such as a called time.

In the present specification, a system means a set of a plurality of constituent elements (devices, modules (components), or the like) and all the constituent elements may or may not be included in a same casing. Accordingly, a plurality of devices accommodated in separate casings and connected via a network and one device in which a plurality of modules are accommodated in one casing both constitute systems.

Further, embodiments of the present technique are not limited to the above-mentioned embodiment and various modifications may be made without departing from the gist of the present technique.

For example, the present technique may be configured as cloud computing in which a plurality of devices share and cooperatively process one function via a network.

In addition, each step described in the above flowchart can be executed by one device or executed in a shared manner by a plurality of devices.

Furthermore, in a case in which one step includes a plurality of processes, the plurality of processes included in the one step can be executed by one device or executed in a shared manner by a plurality of devices.

### Combination Example of Configuration

The present technology can also have the following configuration.

(1)

A light source control device including: a light source control unit that drives a light source in which n (n is 4 or more) light-emitting regions, which emit irradiation light individually, are arranged in a first direction in units of predetermined time Δt, wherein
the light source control unit causes the irradiation light to be emitted m times (m is 2 or more) from each of the light-emitting regions every time the irradiation light is scanned by a predetermined angle in a third direction perpendicular to a second direction corresponding to the first direction and sets an emission interval of each of the light-emitting regions to 2Δt or more and less than nΔt.
   (2)

The light source control device according to (1), wherein the light source control unit sets the emission interval of each of the light-emitting regions to 2Δt.

(3)

The light source control device according to (2), wherein the light source control unit causes the irradiation light to be emitted at a next timing from the light-emitting region that is not adjacent to the light-emitting region that has emitted the irradiation light at a previous timing.

(4)

The light source control device according to (3), wherein the light source control unit is configured so that the irradiation light is emitted from a first light-emitting region at a first timing, the irradiation light is emitted from a second light-emitting region in which an irradiation range of the irradiation light is not adjacent to that of the first light-emitting region at a second timing following the first timing, and the irradiation light is emitted from the first light-emitting region at a third timing following the second timing.

(5)

The light source control device according to (2), wherein the light source control unit causes the irradiation light to be simultaneously emitted from two or more light-emitting regions that are not adjacent to each other.

(6)

The light source control device according to (5), wherein the light source control unit is configured so that the irradiation light is emitted from a first light-emitting region and a second light-emitting region in which irradiation ranges of the irradiation light are not adjacent to each other at a first timing, the irradiation light is emitted from a third light-emitting region and a fourth light-emitting region in which irradiation ranges of the irradiation light are not adjacent to each other at a second timing following the first timing, and the irradiation light is emitted from the first light-emitting region and the second light-emitting region at a third timing following the second timing.

(7)

The light source control device according to any one of (1) to (6), wherein the irradiation light extends long in the second direction.

(8)

The light source control device according to any one of (1) to (7), wherein the second direction is an up-down direction, and
the third direction is a left-right direction.
   (9)

A light source control method including: driving a light source in which n (n is 4 or more) light-emitting regions, which emit irradiation light individually, are arranged in a first direction in units of predetermined time Δt; causing the irradiation light to be emitted m times (m is 2 or more) from each of the light-emitting regions every time the irradiation light is scanned by a predetermined angle in a third direction perpendicular to a second direction corresponding to the first direction; and setting an emission interval of each of the light-emitting regions to 2Δt or more and less than nΔt.

(10)

A distance measuring device including: a light source in which n (n is 4 or more) light-emitting regions, which emit irradiation light individually, are arranged in a first direction;
a light source control unit that drives the light source in units of predetermined time Δt;
a scanning unit that scans the irradiation light in a third direction perpendicular to a second direction corresponding to the first direction;
a light-receiving unit that receives incident light including reflected light of the irradiated light; and
a distance measuring unit that measures a distance based on the incident light, wherein
the light source control unit causes the irradiation light to be emitted m times (m is 2 or more) from each of the light-emitting regions every time the irradiation light is scanned by a predetermined angle in the third direction and sets an emission interval of each of the light-emitting regions to 2Δt or more and less than nΔt.

The advantageous effects described in the present specification are merely exemplary and are not limited, and other advantageous effects may be obtained.

### REFERENCE SIGNS LIST

201 LiDAR
211 Light-emitting unit
212 Scanning unit
213 Light-receiving unit
214 Control unit
215 Data processing unit
221 LD
222 LD driver
231 Polygon mirror
232 Polygon mirror driver
241 Light emission timing control unit
242 Mirror control unit
243 Light reception control unit
244 Overall control unit
252 Histogram generation unit
253 Distance measurement unit
254 Point cloud generation unit

1. A light source control device comprising:
a light source control unit that drives a light source in which n (n is 4 or more) light-emitting regions, which emit irradiation light individually, are arranged in a first direction in units of predetermined time Δt, wherein
the light source control unit causes the irradiation light to be emitted m times (m is 2 or more) from each of the light-emitting regions every time the irradiation light is scanned by a predetermined angle in a third direction perpendicular to a second direction corresponding to the first direction and sets an emission interval of each of the light-emitting regions to 2Δt or more and less than nΔt.

2. The light source control device according to claim 1, wherein
the light source control unit sets the emission interval of each of the light-emitting regions to 2Δt.

3. The light source control device according to claim 2, wherein
the light source control unit causes the irradiation light to be emitted at a next timing from the light-emitting region that is not adjacent to the light-emitting region that has emitted the irradiation light at a previous timing.

4. The light source control device according to claim 3, wherein
the light source control unit is configured so that the irradiation light is emitted from a first light-emitting region at a first timing, the irradiation light is emitted from a second light-emitting region in which an irradiation range of the irradiation light is not adjacent to that of the first light-emitting region at a second timing following the first timing, and the irradiation light is emitted from the first light-emitting region at a third timing following the second timing.

5. The light source control device according to claim 2, wherein
the light source control unit causes the irradiation light to be simultaneously emitted from two or more light-emitting regions that are not adjacent to each other.

6. The light source control device according to claim 5, wherein
the light source control unit is configured so that the irradiation light is emitted from a first light-emitting region and a second light-emitting region in which irradiation ranges of the irradiation light are not adjacent to each other at a first timing, the irradiation light is emitted from a third light-emitting region and a fourth light-emitting region in which irradiation ranges of the irradiation light are not adjacent to each other at a second timing following the first timing, and the irradiation light is emitted from the first light-emitting region and the second light-emitting region at a third timing following the second timing.

7. The light source control device according to claim 1, wherein
the irradiation light extends long in the second direction.

8. The light source control device according to claim 1, wherein
the second direction is an up-down direction, and
the third direction is a left-right direction.

9. A light source control method comprising:
driving a light source in which n (n is 4 or more) light-emitting regions, which emit irradiation light individually, are arranged in a first direction in units of predetermined time Δt;
causing the irradiation light to be emitted m times (m is 2 or more) from each of the light-emitting regions every time the irradiation light is scanned by a predetermined angle in a third direction perpendicular to a second direction corresponding to the first direction; and
setting an emission interval of each of the light-emitting regions to 2Δt or more and less than nΔt.

10. A distance measuring device comprising:
a light source in which n (n is 4 or more) light-emitting regions, which emit irradiation light individually, are arranged in a first direction;
a light source control unit that drives the light source in units of predetermined time Δt;
a scanning unit that scans the irradiation light in a third direction perpendicular to a second direction corresponding to the first direction;
a light-receiving unit that receives incident light including reflected light of the irradiated light; and
a distance measuring unit that measures a distance based on the incident light, wherein
the light source control unit causes the irradiation light to be emitted m times (m is 2 or more) from each of the light-emitting regions every time the irradiation light is scanned by a predetermined angle in the third direction and sets an emission interval of each of the light-emitting regions to 2Δt or more and less than nΔt.
